(19) United States
(12) Patent Application Publication
(10) Pub. No.: US 2021/0142429 A1
(43) Pub. Date: May 13, 2021

(54) SYSTEM, APPARATUS, AND METHOD FOR DISTRIBUTING REAL ESTATE UNIT INFORMATION THROUGH A DIGITAL VOICE VIRTUAL ASSISTANT

(71) Applicant: Justin Scott Cullifer, Greensboro, GA (US)

(72) Inventor: Justin Scott Cullifer, Greensboro, GA (US)

(21) Appl. No.: 16/949,790

(22) Filed: Nov. 13, 2020

Related U.S. Application Data
(60) Provisional application No. 62/934,628, filed on Nov. 13, 2019.

(51) Int. Cl. G06Q 50/16; G06Q 10/10; G06Q 30/00; G06Q 30/02; G06F 9/451; G06F 16/29; G10L 15/22

(52) U.S. Cl. CPC G06Q 50/16; G06Q 10/10; G06Q 30/0185; G06Q 30/0277; G10L 15/30; G06F 16/29; G10L 15/22; G10L 2015/223; G06F 9/453

(57) ABSTRACT

A system, apparatus, and business method for distributing real estate unit information through a real estate digital voice virtual assistant device. In use, a real estate professional, acting as a listing agent, may control responses to questions asked of the real estate digital voice virtual assistant real estate technology. The real estate digital voice virtual assistant may be present and accessible twenty-four hours a day and seven days a week, capable of providing information pertaining to a property listing. The system increases the ability of the listing agent to effectively engage with prospective real estate buyers and lessees.

### CROSS-REFERENCE TO RELATED APPLICATION

This application claims the benefit of priority of U.S. provisional application No. 62/934,628, filed Nov. 13, 2019, the contents of which are incorporated herein by reference in their entirety.

### BACKGROUND OF THE INVENTION

The present invention relates to real estate sales, and more particularly systems and methods for distributing information for a real estate unit.

When real estate professionals list a property for sale or lease, they are limited in the amount of information they can share about the property. This limits the useful information prospective buyers and lessees have in order to make a purchase or lease decision.

One method to convey real estate property information is the use of printed documents that require re-printing to improve or otherwise manipulate their content. Another method to convey real estate property information is for the real estate professional, acting as the listing agent, to be present with each prospective buyer or lessee as they evaluate the unit. This can be difficult when balancing other demands on the listing agent's time. A final method to convey real estate property information is to use online multiple listing and aggregator services to publish information on the Internet.

As can be seen, there is a need for improved systems, apparatus, and method for quickly responding to inquiries to provide information about a real estate property unit to prospective buyers and lessees.

### SUMMARY OF THE INVENTION

Broadly, embodiments of the present invention provide a system, method, apparatus, and computer program product for distributing real estate unit information through a digital voice virtual assistant.

Through the various aspects of the present invention, a real estate professional, acting as a listing agent, may control one or more responses to one or more user questions asked of a digital voice virtual assistant specially configured for interacting with and responding to inquiries in real estate. The digital voice virtual assistant may be present and accessible twenty-four hours a day and seven days a week to provide information pertaining to a property listing. The present invention is therefore capable of increasing the ability of a listing agent to effectively engage with prospective real estate buyers and lessees.

In one aspect of the present invention, a real estate system may enable a user such as, for example without limitation, a real estate buyer or lessee, to access a digital voice virtual assistant to ask queries and receive answers to those queries. The user may receive more useful information in order to inform a buying or leasing decision.

Previously, real estate professionals had to rely on limited tools, such as single or multiple page paper leaflets, to effectively convey property information to prospective buyers and lessees. In a further aspect, the system and software of the present invention enhances the interactivity and personalization of sharing this information.

Other methods and system devices and systems—including printed and internet publishing—that exist are not interactive and responsive to unique and unpredictable questions from prospective real estate buyers and lessees. Using such systems has therefore been fixed in nature and lacking elements of interactivity. In a still further aspect, the present invention remedies this shortcoming of previous options by providing a solution which is user-friendly and effective.

These and other features, aspects and advantages of the present invention will become better understood with reference to the following drawings, description and claims.

### BRIEF DESCRIPTION OF THE DRAWINGS

FIG. 1 illustrates the functionality process and the voice functionalities of the system;

FIG. 2 illustrates a system architecture for distributing real estate unit information through a digital voice virtual assistant, and the main Glass House Guide skill architecture;

FIG. 3 is a flow chart illustrating a method of practicing the invention, also referred to as the Glass House Guide interaction process;

FIG. 4 is a continuation of the method as in FIG. 3;

FIG. 5 is a continuation of the method as in FIGS. 3-4; and

FIG. 6 is a continuation of the method as in FIGS. 3-5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

In an exemplary embodiment, the present invention provides a system, method, apparatus, and computer program product for distributing real estate unit information through a digital voice virtual assistant.

In an exemplary embodiment of the present invention, a real estate professional, acting as the listing agent, may control one or more responses to one or more user questions asked of a digital voice virtual assistant specially configured for interacting to inquiries in real estate. The digital voice virtual assistant can be present and accessible twenty-four hours a day and seven days a week, therefore increasing the listing agent's ability to effectively engage with prospective real estate buyers and lessees.

By allowing a real estate buyer or lessee to use a digital voice virtual assistant to ask queries and receive answers to those queries, the buyer or lessee will have more useful information in order to inform their buying or leasing decision.

The present invention provides a method for real estate professionals to provide real estate information without having to rely upon limited tools, such as single or multiple page paper leaflets, to effectively convey property information to prospective buyers and lessees. The system and software of the present invention enhances the interactivity and personalization of sharing of property information.

The present invention provides an unprecedented improvement over previously available devices and systems, including printed and Internet publishing, and provides an interactive system that is capable of responding to unique and unpredictable questions from prospective real estate buyers and lessees. The present invention distinguishes over and differs from previous systems which were fixed in nature and lacked elements of interactivity.

A system in accordance with the present invention may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

Referring now to the Figures, an exemplary embodiment of the present invention is shown. FIG. 1 illustrates the functionality process and the voice functionalities of the system. FIG. 2 illustrates a system architecture for distributing real estate unit information through a digital voice virtual assistant; and the main Glass House Guide skill architecture. FIG. 3-6 are flow charts illustrating a method of practicing the invention; also referred to as the Glass House Guide interaction process.

As seen in reference to the drawings of FIGS. 1-6, a system in accordance with an exemplary embodiment of the present invention may comprise a real estate system digital voice virtual assistant device, and may further comprise a Glass House Guide Backend and a Skill Backend, which are responsive to communications through the real estate system digital voice virtual assistant device.

The Skill Backend is configured to handle intent logic, and to create and send interactions with the Glass House Guide Backend to retrieve real estate property information, real estate professional information, and other pertinent information to facilitate the voice interactive experience.

The Glass House Guide Backend retrieves database information and associates the real estate system digital voice virtual assistant device to unique real estate property records. The Glass House Guide Backend also creates, reads, updates and deletes real estate system digital voice virtual assistance device sessions. The Skill Backend validates digital voice virtual assistance device sessions.

A method according to aspects of the invention includes process steps facilitating the communication of interactions to convey real estate information corresponding to a specified property.

The components, steps and elements of this invention work together to make an association between the real estate digital voice virtual assistant hardware device and a unique Glass House Guide real estate property record prepared for each property unit. This ensures that the answers to questions asked by the prospective real estate buyers or lessees are specific to the real estate property in question. This is an original user experience for the buyers and lessees, where otherwise they would have to ask a series of protracted queries in order to get specific information about the property. Correlating a hardware device to a property record association is an element of the invention.

A method of practicing the invention may include one or more of the following process steps:

Step 1: Real estate professional registers for Glass House Guide service on the Glass House Guide website.

Step 2: Real estate professional creates a Property Record in the Glass House Guide website system. This property is assigned a unique Property Identifier.

Step 3: Real estate professional invokes Glass House Guide skills in the digital voice virtual assistant device.

Step 4: The digital voice virtual assistant device asks the real estate professional for the unique Property Identifier, validates its accuracy, and using the Skill Backend and Glass House Guide Backend creates an association of the digital voice virtual assistant device to Property Record.

Step 5: The digital voice virtual assistant device is now accessible by prospective real estate buyers or lessees to be asked a plurality of question about the property and retrieve an answer to the question.

Step 6: A real estate buyer or lessee invokes the Glass House Guide skill on the digital voice virtual assistant device and asks it a question about the real estate property.

Step 7: The Glass House Guide skill retrieves the response using the Skill Backend and Glass House Guide Backend.

Step 8: The Glass House Guide skill response audibly or visually with the response to the question asked by the real estate buyer or lessee.

Other aspects of the invention may include one or more of the following additional processes or process steps and combinations thereof.

Additional Step 1: Build one or more digital voice virtual assistant skills that interact with digital voice virtual assistant hardware using digital voice virtual assistant hardware existing infrastructures from their licensees and manufacturers.

Additional Step 2: Build an original Skill Backend to handle intent logic, called the Glass House Guide backend for database retrievals, create and send responses to the digital voice virtual assistant hardware infrastructure.

Additional Step 3: Build an original Glass House Guide Backend to create, read, update and delete database information that is used to associate properties to digital voice virtual assistant hardware devices and handle device sessions.

In some embodiments, the Skill Backend and Database Backend could be combined into a single Backend service.

The existing elements of this invention could be repurposed to perform an identical function in other areas where digital voice virtual assistant hardware devices are present. By way of non-limiting example, automobiles that are equipped with digital voice virtual assistant technologies can have a service utilizing the components described in this invention to provide detailed answers to questions regarding the specific automobile. Moreover, any consumer purchasable asset that is equipped with digital voice virtual assistant technologies can have a service utilizing the components described in this invention to provide detailed answers to questions regarding the specific purchasable asset.

With reference to FIGS. 1 through 6 an exemplary embodiment is shown. A functionality in accordance with an exemplary embodiment of the present invention comprises a user, an Alexa Skill, a Skill Backend, and a Glass House Backend. In some embodiments, the Alexa Skill is capable of handling the user session. The Skill Backend is capable of handling the intent logic and providing responses. The Glass House Guide Backend is retrieving database information and associating properties and real estate units with system devices. In use, the user may say utterances to the Alexa Skill. The Alexa Skill is capable of processing the utterances, and identifies the intent thereof. The utterance may comprise a request for information. The Alexa Skill may send the request to the Skill Backend (Lambda). The Alexa Skill may receive a response from the Skill Backend. The Alexa Skill may play the response from the Skill Backend. The Alexa Skill is capable of handling the user session and in this functionality, the Alexa Skill may handle the user session. The Skill Backend may handle the intent logic; and in response to a request interpreted thereby, call the Glass House API to retrieve information and create and send a response. The Glass House Guide Backend retrieves database information and associates properties with devices.

In an alternative functionality in accordance with the present invention, the user may say utterances to the Alexa Skill. The Alexa Skill is capable of processing the utterances, and identifies the intent thereof. The utterance may comprise a request for information. The Alexa Skill may send the request to the Skill Backend (Lambda). The Alexa Skill may receive a response from the Skill Backend. The Alexa Skill may play the response from the Skill Backend. The Skill Backend may handle the intent logic; and in response to a request interpreted thereby, call the Glass House API to retrieve information and create and send a response. In some embodiments, the Skill Backend is capable of validating the device session. In this embodiment of the alternative functionality, the Skill Backend may validate the device session. The Glass House Guide Backend retrieves database information and associates properties with devices. The Glass House Guide Backend is capable of handling the device session. In this embodiment of the alternative functionality, the Glass House Guide Backend may handle the device session.

Referring now to FIG. 2, an exemplary embodiment of the present invention is shown describing the Main Glass House Guide Skill Architecture. FIG. 2 illustrates a system architecture for distributing real estate unit information through a digital voice virtual assistant; and the main Glass House Guide skill architecture. The architecture may comprise an IAM role, a Glass House Guide Database, a Glass House Guide Skill, a Glass House Guide Backend, a Lambda Function, Cloud Watch Logs, and an Alexa Enable Device. The IAM Role is capable of granting access to the system. The Glass House Database is capable of storing data. The Glass House Guide Skill is capable of transmitting instructions. The Glass House Guide Backend is capable of retrieving and transmitting information regarding real estate property units, and authorized or connected devices. The Lambda function has multiple capabilities and functions central to system operation. Cloud watch logs are capable of logging system events. The Alexa Enable Device is capable of receiving and transmitting messages, and providing function in accordance with the present invention of a real estate system digital virtual voice assistance device.

Referring now to FIG. 3, a flow chart illustrates a method of practicing the invention; also referred to as the Glass House Guide interaction process. A user may be a first user who is a real estate professional. A user may also be a second user comprising a real estate buyer, a real estate lessee, a prospective real estate buyer, a prospective real estate lessee or combinations thereof. The user may open the skill, and say utterances. In response to the user action, the Alexa Enable Device may be actuated to create a launch request, identify user intent and send a request, and reproduce or convey an ultimate response to the user. The AWS Lambda may request device information, and validate device information. The AWS Lambda may ascertain whether a specific real estate unit is associated with the system. If a specific real estate unit is associated with the system, the AWS Lamdba may start a buyer workflow. If a specific real estate unit is not associated with the system, the AWS Lambda may initiate a real estate unit registration workflow. The AWS Lambda may perceive and handle intent, contact API, request information from the Glass House Guide Database, receive requested information from the Glass House Guide Database, validate received information and create a response containing such information, which may then be conveyed to the Alexa Enable Device and ultimately to the user. The Glass House Guide Database is capable of receiving and storing information regarding real estate property units and provides such information in response to requests received from the AWS Lambda.

FIGS. 4 through 6 further describe a process in accordance with an exemplary embodiment of the present invention.

With reference to FIG. 4, a user implemented process for accessing the system is shown, wherein the user may be a second user comprising a real estate buyer, a real estate lessee, a prospective real estate buyer, a prospective real estate lessee or combinations thereof. The user may access and open the Glass House Guide, actuating the real estate system virtual voice assistant. Opening the Glass House Guide may actuate the real estate system virtual voice assistant, and in response thereto, will activate the voice assistant cloud service, the Glass House Guide Backend. Activation of the Glass House Guide Backend may result in creation or location of a response which may be conveyed or transmitted to the skill back end, then to the voice assistant cloud service, then proceed to the virtual voice assistant, which conveys the response to the subject user. A nonlimiting example of a response may be, “Welcome to {ADDRESS of Real Estate Unit}, {What is your name?}.”

Referring now to FIG. 5, a user implemented process is shown, wherein the user may be a second user comprising a real estate buyer, a real estate lessee, a prospective real estate buyer, a prospective real estate lessee or combinations thereof. The user may provide a communication which may comprise a greeting or salutation to the real estate system digital voice virtual assistant, such as for example without limitation, “I'm {USER NAME}”. The user communication, greeting or salutation may reach and be received by a real estate digital voice virtual assistant. The communication may then be transmitted or conveyed to a voice assistant cloud service. The communication may then be transmitted or conveyed to a skill backend. The communication may then be transmitted or conveyed to a Glass House Guide Backend. Processing of the communication by the Glass House Guide Backend may result in creation or location of a response to the communication. The response may be conveyed or transmitted to the skill back end, then to the voice assistant cloud service, then proceed to the digital voice virtual assistant, which conveys the response to the subject user. A nonlimiting example of a response may be, “Welcome {USER NAME}. {INTRODUCTION}.”

Referring now to FIG. 6, a user implemented process is shown, wherein the user may be a second user comprising a real estate buyer, a real estate lessee, a prospective real estate buyer, a respective real estate lessee or combinations thereof. The user may provide a communication which may comprise a real estate question or command. The user communication, utterance, question or command may reach and be received by a real estate digital voice virtual assistant. The communication may then be transmitted or conveyed to a voice assistant cloud service. The communication may then be transmitted or conveyed to a skill backend. The communication may then be transmitted or conveyed to a Glass House Guide Backend. Processing of the communication by the Glass House Guide Backend may result in creation or location of a response to the communication. The response may be conveyed or transmitted to the skill back end, then to the voice assistant cloud service, then proceed to the digital voice virtual assistant, which conveys the response to the subject user.

In an exemplary embodiment, a real estate system for processing and distributing real estate information, the real estate system comprises a real estate digital voice virtual assistant device comprising a Glass House Guide Skill, a real estate system skill backend, and a real estate system Glass House Guide backend. The real estate system skill backend and the real estate system Glass House Guide backend are capable of receiving from a user, data concerning a property record; creating and storing a unique property identifier associated with the property record; and creating an association of the real estate digital voice virtual assistant device Glass House Guide Skill to the property record.

In an exemplary embodiment, the present invention comprises a method for distributing information concerning a real estate unit which includes one or more of the following steps and combinations thereof.

a) providing a real estate system for processing and distributing real estate information as described herein;

b) a first user comprising a real estate professional registering on a real estate system website for real estate services provided by the real estate system on the real estate website;

c) the real estate professional creating a property record of the real estate unit in the real estate system on the real estate website, the property record further comprising a unique property identifier;

d) the real estate professional accessing a real estate system digital voice virtual assistant device, and actuating at least one real estate system Glass House Guide skill of the real estate system digital voice virtual assistant device;

e) the real estate system validating the property record;

f) after validation of the property record, the real estate system digital voice virtual assistant device being accessible, and accessed by, a second system user to receive information concerning the real estate unit from the real estate system by asking the real estate system digital voice virtual assistant device a question about the real estate unit;

g) after receiving a question from a second system user about the real estate unit, the real estate system Glass House Guide skill retrieving a response to the question using the real estate system Skill Backend and the real estate system Glass House Guide Backend; and

h) the real estate system Glass House Guide skill responding audibly or visually with the response to the question asked by the second system user.

In an exemplary embodiment, the real estate system validates the property record by a method including one or more of the following steps and combinations thereof:

a) the real estate system digital voice virtual assistant device asks the real estate professional for the unique property identifier;

b) the real estate system digital voice virtual assistant device assesses and confirms the accuracy of the unique property identifier; and

c) the real estate system digital voice virtual assistant utilizes the real estate system skill backend and real estate system guide backend to create an association of the digital voice virtual assistant device to the property record.

In an exemplary embodiment, nonlimiting examples of the second system may include prospective real estate buyers or prospective real estate lessees.

In an exemplary embodiment, the prospective real estate buyer or prospective real estate lessee receives information concerning the real estate unit associated with the property record by a method comprising the following steps:

a) the second user receives a unique property identifier associated with a real estate unit promoted or advertised by the first user; and

b) the second user accesses the real estate system digital voice virtual assistant to receive information about the real estate property unit by providing the unique property identifier and actuating at least one real estate system Glass House Guide skill of the real estate system digital voice virtual assistant device.

In an exemplary embodiment of the present invention, the question about the real estate unit asked by the second system user may comprise a request for real estate property information made by the second system user using a device located in a home or a vehicle owned by the second system user.

In an exemplary embodiment of the method, the second user may access the real estate system and the real estate system digital voice virtual assistant device, and thereby invoke the Glass House Guide skill on the real estate digital voice virtual assistant device. The second user may ask the real estate digital voice virtual assistant device a question about the real estate property. The real estate system Glass House Guide skill may retrieve a response to the question using the real estate system Skill Backend and real estate system Glass House Guide Backend. The real estate system Glass House Guide skill may then respond audibly or visually with the response to the question asked by the second system user.

The second system user may obtain information concerning the property associated the property record by a method including one or more of the following steps:

a) the second system user asks the real estate system digital voice virtual assistant device a plurality of questions about the property;

b) the real estate system digital voice virtual assistant device retrieves an answer to each of said plurality of questions; and

c) the real estate system digital voice virtual assistant device provides answers to each of the plurality of questions.

In summary, an exemplary embodiment of the present invention may provide a method for distributing information concerning a real estate unit, the method including the steps of:

a) providing a real estate system for processing and distributing real estate information, the real estate system comprising:
i) a real estate digital voice virtual assistant device comprising a Glass House Guide Skill;
ii) a real estate system skill backend; and
iii) a real estate system Glass House Guide backend;
wherein the real estate system skill backend and the real estate system Glass House Guide backend are capable of: receiving from a user, data concerning a property record; creating and storing a unique property identifier associated with the property record; and creating an association of the real estate digital voice virtual assistant device Glass House Guide Skill to the property record;

b) a first user comprising a real estate professional registering on a real estate system website for real estate services provided by the real estate system on the real estate website;

c) the real estate professional creating a property record of the real estate unit in the real estate system on the real estate website, the property record further comprising a unique property identifier;

d) the real estate professional accessing a real estate system digital voice virtual assistant device, and actuating at least one real estate system Glass House Guide skill of the real estate system digital voice virtual assistant device;

e) the real estate system validating the property record; by a validation process comprising the steps of:
i) the real estate system digital voice virtual assistant device asks the real estate professional for the unique property identifier;
ii) the real estate system digital voice virtual assistant device assesses and confirms the accuracy of the unique property identifier; and
iii) the real estate system digital voice virtual assistant utilizes the real estate system skill backend and real estate system guide backend to create an association of the digital voice virtual assistant device to the property record;

f) after validation of the property record, the real estate system digital voice virtual assistant device being accessible to a second system user comprising a prospective real estate buyer or prospective real estate seller, the real estate system digital voice virtual assistant then being accessed by the second system user from a device located in a home or vehicle of the second system user, to request and receive information concerning the real estate unit from the real estate system, by a process including:
i) the second system user asking the real estate system digital voice virtual assistant device a question about the real estate unit;
ii) the second user receiving a unique property identifier associated with a real estate unit promoted or advertised by the first user; and
iii) the second user accessing the real estate system digital voice virtual assistant to ask a question receive information about the real estate property unit by providing the unique property identifier, thereby invoking the Glass House Guide skill on the real estate digital voice assistant device, and asking the real estate digital voice assistant device a question about the real estate property;

g) after receiving a question from a second system user about the real estate unit, the real estate system Glass House Guide skill retrieving a response to the question using the real estate system Skill Backend and the real estate system Glass House Guide Backend; and
h) the real estate system Glass House Guide skill responding audibly or visually with the response to the question asked by the second system user.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A real estate system for processing and distributing real estate information, the real estate system comprising:
a real estate digital voice virtual assistant device comprising a Glass House Guide Skill;
a real estate system skill backend; and
a real estate system Glass House Guide backend;
wherein the real estate system skill backend and the real estate system Glass House Guide backend are capable of: receiving from a user, data concerning a property record; creating and storing a unique property identifier associated with the property record; and creating an association of the real estate digital voice virtual assistant device Glass House Guide Skill to the property record.

2. A method for distributing information concerning a real estate unit, the method including the steps of:
providing a real estate system for processing and distributing real estate information as in claim 1;
a first user comprising a real estate professional registering on a real estate system website for real estate services provided by the real estate system on the real estate website;
the real estate professional creating a property record of the real estate unit in the real estate system on the real estate website, the property record further comprising a unique property identifier;
the real estate professional accessing a real estate system digital voice virtual assistant device, and actuating at least one real estate system Glass House Guide skill of the real estate system digital voice virtual assistant device;
the real estate system validating the property record;
after validation of the property record, the real estate system digital voice virtual assistant device being accessible, and accessed by, a second system user to receive information concerning the real estate unit from the real estate system by asking the real estate system digital voice virtual assistant device a question about the real estate unit;
after receiving a question from a second system user about the real estate unit, the real estate system Glass House Guide skill retrieving a response to the question using the real estate system Skill Backend and the real estate system Glass House Guide Backend; and
the real estate system Glass House Guide skill responding audibly or visually with the response to the question asked by the second system user.

3. The method of claim 2 wherein the real estate system validates the property record by a method including one or more of the following steps:
the real estate system digital voice virtual assistant device asks the real estate professional for the unique property identifier,
the real estate system digital voice virtual assistant device assesses and confirms the accuracy of the unique property identifier; and
the real estate system digital voice virtual assistant utilizes the real estate system skill backend and real estate system guide backend to create an association of the digital voice virtual assistant device to the property record.

4. The method of claim 3 wherein the second system user comprises a prospective real estate buyer or a prospective real estate lessee, and wherein the prospective real estate buyer or prospective real estate lessee receives information concerning the real estate unit associated with the property record by a method comprising the following steps:
the second user receives a unique property identifier associated with a real estate unit promoted or advertised by the first user; and
the second user accesses the real estate system digital voice virtual assistant to receive information about the real estate property unit by providing the unique property identifier and actuating at least one real estate system Glass House Guide skill of the real estate system digital voice virtual assistant device.

5. The method of claim 4 wherein the question about the real estate unit asked by the second system user comprises a request for real estate property information made by the second system user using a device located in a home or a vehicle owned by the second system user.

6. The method of claim 5 wherein:
the second user accesses the real estate system and the real estate system digital voice virtual assistant device, and thereby invokes the Glass House Guide skill on the real estate digital voice virtual assistant device,
the second user asks the real estate digital voice virtual assistant device a question about the real estate property;
the real estate system Glass House Guide skill retrieves a response to the question using the real estate system Skill Backend and real estate system Glass House Guide Backend; and
the real estate system Glass House Guide skill responds audibly or visually with the response to the question asked by the second system user.

7. The method of claim 2 wherein the second system user obtains information concerning the property associated the property record by a method including one or more of the following steps:
the second system user asks the real estate system digital voice virtual assistant device a plurality of questions about the property;
the real estate system digital voice virtual assistant device retrieves an answer to each of said plurality of questions; and
the real estate system digital voice virtual assistant device provides answers to each of the plurality of questions.

8. A method for distributing information concerning a real estate unit, the method including the steps of:
providing a real estate system for processing and distributing real estate information, the real estate system comprising:
a real estate digital voice virtual assistant device comprising a Glass House Guide Skill;
a real estate system skill backend; and
a real estate system Glass House Guide backend;
wherein the real estate system skill backend and the real estate system Glass House Guide backend are capable of: receiving from a user, data concerning a property record; creating and storing a unique property identifier associated with the property record; and creating an association of the real estate digital voice virtual assistant device Glass House Guide Skill to the property record;
a first user comprising a real estate professional registering on a real estate system website for real estate services provided by the real estate system on the real estate website;
the real estate professional creating a property record of the real estate unit in the real estate system on the real estate website, the property record further comprising a unique property identifier;
the real estate professional accessing a real estate system digital voice virtual assistant device, and actuating at least one real estate system Glass House Guide skill of the real estate system digital voice virtual assistant device;
the real estate system validating the property record; by a validation process comprising the steps of:
the real estate system digital voice virtual assistant device asks the real estate professional for the unique property identifier,
the real estate system digital voice virtual assistant device assesses and confirms the accuracy of the unique property identifier; and
the real estate system digital voice virtual assistant utilizes the real estate system skill backend and real estate system guide backend to create an association of the digital voice assistant device to the property record;
after validation of the property record, the real estate system digital voice virtual assistant device being accessible to a second system user comprising a prospective real estate buyer or prospective real estate seller, the real estate system digital voice virtual assistant then being accessed by the second system user from a device located in a home or vehicle of the second system user, to request and receive information concerning the real estate unit from the real estate system, by a process including:
the second system user asking the real estate system digital voice virtual assistant device a question about the real estate unit;
the second user receiving a unique property identifier associated with a real estate unit promoted or advertised by the first user; and
the second user accessing the real estate system digital voice virtual assistant to ask a question receive information about the real estate property unit by providing the unique property identifier, thereby invoking the Glass House Guide skill on the real estate digital voice virtual assistant device, and asking the real estate digital voice assistant device a question about the real estate property;
after receiving a question from a second system user about the real estate unit, the real estate system Glass House Guide skill retrieving a response to the question using the real estate system Skill Backend and the real estate system Glass House Guide Backend; and
the real estate system Glass House Guide skill responding audibly or visually with the response to the question asked by the second system user.
